(19) United States
(12) Patent Application Publication
(10) Pub. No.: US 2002/0076356 A1
(43) Pub. Date: Jun. 20, 2002

(54) Apparatus for receiving samples

(76) Inventors: Thomas Rothmann, Langenfeld (DE); Andreas Schafer, Leverkusen (DE)

Correspondence Address: LEON R. YANKWICH, YANKWICH & ASSOCIATES, 130 BISHOP ALLEN DRIVE, CAMBRIDGE, MA, 02139, US

(21) Appl. No.: 10/002,904

(22) Filed: Nov. 15, 2001

(30) Foreign Application Priority Data
Dec. 16, 2000 (DE) DE 200 21 326.1

(51) Int. Cl. B01L 3/00

(52) U.S. Cl. 422/102; 422/104

(57) ABSTRACT

An apparatus is disclosed comprising a supporting plate with bores for receiving sample-receiving vessels and connection means for irreversibly connecting the vessels to the plate. Such an apparatus is useful for connecting individual vessels or sets of vessels used for collecting samples and assembling them permanently into a fixed array for further procedures, e.g., testing of collected samples.

### FIELD OF THE INVENTION

The invention relates to an apparatus comprising at least one or more vessels which can be connected together, and a supporting plate for receiving these vessels, wherein the vessel and the supporting plate can be irreversibly connected together. Among other uses, such apparatus can be used as sample-receiving vessels in biochemical and immunological research, in medicinal diagnostics, in the chemical and pharmaceutical industries and in biotechnology.

### BACKGROUND OF THE INVENTION

In these fields of application, sample-receiving vessels will be used, for example, for the cultivation of bacteria, for lysis of cells, as washing or elution vessels or as analysis vessels in screening processes.

Sample-receiving vessels for biological and chemical samples are especially used in the analysis of many different samples.

On the one hand, individual vessels are used, but with the multitude of different samples tested there is a danger of mixing up individual samples. On the other hand, the use of micro-titre plates is widespread. Micro-titre plates, which have a plurality of sample vessels in a grid of for example 8×12 or n8×m12, have the disadvantage that flexible and individual treatment of individual samples is not possible.

Hence the object of the invention is to provide one or more vessels for receiving preferably biological and/or chemical samples which do not have the aforementioned disadvantages and can especially be used as elution vessels for a multitude of individual samples in analysis or screening processes. The object of the invention is especially to provide sample-receiving vessels which exclude mixing up of individual samples but allow individual treatment of the sample vessels.

### SUMMARY OF THE INVENTION

The invention solves these tasks by provision of an apparatus comprising at least one, or more, vessels which are connected together, and a supporting plate which is suitable for receiving the vessels, characterized in that a vessel and the supporting plate can be irreversibly connected to one another.

### DESCRIPTION OF THE DRAWING

FIG. 1 shows a perspective elevation of an exemplary embodiment (1) of the invention.

### DETAILED DESCRIPTION OF THE INVENTION

In the sense of the present invention, the term “supporting plate” is to be understood as any apparatus which is suitable for receiving sample vessels.

In connection with the current invention, vessels are to be understood as any type of vessels which is suitable for receiving samples, irrespective of their shape, size or material.

The vessels according to the invention are preferably cylindrical in shape with an inlet opening and a rounded base, with a volume of at least 10 μl, preferably 10 μl to 10 ml. Vessels with a volume of 10 μl to 1 ml are especially preferred.

In one embodiment of the invention, the individual vessels are connected to one another via a web on their upper edge. It is preferred that 8 vessels are connected to one another.

In a preferred embodiment of the invention, the supporting plate has bores which are suitable for receiving the vessels according to the invention. According to the invention, plates are used which can preferably receive 8, and especially preferably 96, vessels. Here, the bores are either disposed adjacently in a row, or in a matrix in rows, or in columns orthogonal thereto. It is preferred that the bores on the plate are disposed in a matrix of n8 and m12 bores. The parameters n and m are independent of one another and can denote one of the integers 0, 1, 2, 3 or 4, wherein n+m>0. In an especially-preferred embodiment, n−m=1 and the plate has 8×12 bores.

The supporting plate can have any dimensions. In a preferred embodiment of the invention, supporting plates are used with the dimensions of a standard micro-titre plate of 127.7±0.25 mm×85.5±0.25 mm.

The supporting plate and vessel are preferably connected together via an apparatus so that they cannot be separated without destruction of this apparatus. Advantageously, this apparatus is embodied by a plug-in connection, wherein in a preferred embodiment of the invention a part of the plug-in connection is attached to the sample-receiving vessel and connects the supporting plate with the vessel via a barb. If the barb is guided into a suitable bore, which is not the bore for receiving the vessels, the vessel and the plate are irreversibly connected together.

Vessels, plug-in connection and supporting plate can be produced from any material; it is preferred that they are produced from polycarbonate (PC), polypropylene (PP), polyethylene (PE), polyester (PET) or glass.

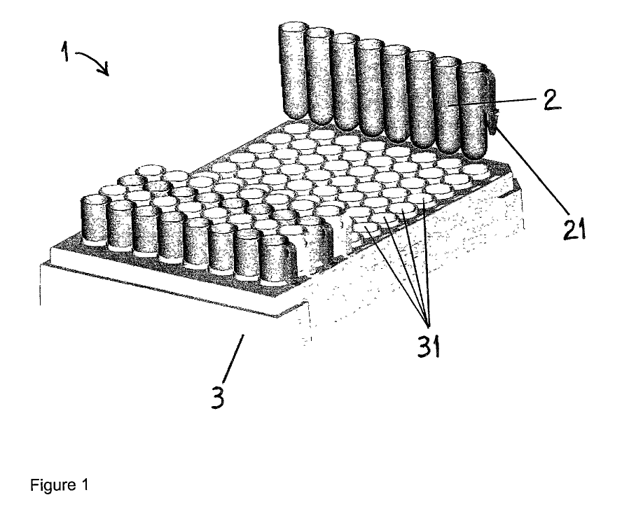

FIG. 1 shows a perspective elevation of an exemplary embodiment (1) of the invention. In this preferred embodiment, the supporting plate (3) has 96 bores (31) which are disposed in an 8×12 X-Y grid. 8 sample-receiving vessels (2) are connected together, wherein a vessel disposed on the end is equipped with a plug-in connection (21). In this exemplary embodiment, the plug-in connection (21) has the shape of a barb. The supporting plate and the sample-receiving vessels can be irreversibly connected together with the help of this barb.

1. An apparatus (1) comprising at least one or more vessels (2) which can be connected to one another, and a supporting plate having bores for receiving the vessels, characterized in that
the vessel (2) and the supporting plate (3) can be irreversibly connected to one another via an apparatus (21).

2. The apparatus according to claim 1, characterized in that the vessels and the supporting plate are irreversibly connected to one another via a plug-in connection.

3. The apparatus according to claim 2, characterized in that a part of the plug-in connection is in the shape of a barb.

4. The apparatus according to one of claims 1, 2 or 3, characterized in that the vessels are disposed adjacently in a row and are connected to one another.

5. The apparatus according to claim 4, characterized in that 8 vessels are disposed adjacently in a row and are connected to one another.

6. The apparatus according to one of claims 1, 2 or 3, characterized in that the supporting plate can receive 96 vessels.

7. The apparatus according to one of claims 1, 2 or 3, characterized in that the bores on the supporting plate are disposed in the form of a matrix of n8×m12 bores, wherein n and m, independent of one another, can denote an integer 0, 1, 2, 3 or 4, where n+m>0.
